(19) United States
(12) Patent Application Publication
(10) Pub. No.: US 2025/0156327 A1
(43) Pub. Date: May 15, 2025

(54) LOW LATENCY MEMORY ACCESS FOR CPUS IN AUTONOMOUS VEHICLES

(71) Applicant: Apollo Autonomous Driving USA LLC, Sunnyvale, CA (US)

(72) Inventor: ZHENWEI YU, Sunnyvale, CA (US)

(21) Appl. No.: 18/506,399

(22) Filed: Nov. 10, 2023

(51) Int. Cl. G06F 12/0811; B60W 60/00

(52) U.S. Cl. CPC G06F 12/0811; B60W 60/001

(57) ABSTRACT

In one embodiment, a system determines a plurality of memory controllers available at a central processing unit (CPU) chipset of an autonomous driving system (ADS) for an autonomous driving vehicle (ADV), the CPU chipset having a plurality of processing cores. The system partitions the plurality of memory controllers at the CPU chipset into N regions. The system determines a shared cache memory at the CPU chipset that is shared among the plurality of processing cores. The system partitions the shared cache memory into N segments according to the N regions. The system configures CPU chipset settings to associate each memory controller in the N regions to a segment of the shared cache memory in the respective region. Data and/or instruction sets are accessed by the CPU chipset from a memory controller through a segment of the cache memory that is associated to the memory controller.

### TECHNICAL FIELD

Embodiments of the present disclosure relate generally to operating autonomous driving vehicles. More particularly, embodiments of the disclosure relate to low latency memory access for central processing units in autonomous driving vehicles (ADVs).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. The computing platform for autonomous driving is required to be high performance for the critical operations. Operational tasks require the central processing units (CPU) of the computing platform to access data from memory to read and write data to process instructions when executing autonomous driving tasks. The latency of the data access is critical for the performance of the CPU. The lower the latency, the higher the performance of the CPU.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram of a memory access configuration module according to one embodiment.

FIGS. 5A-5B is a block diagram and a layout diagram of a CPU chipset configuration according to one embodiment.

FIGS. 6A-6B is a block diagram and a layout diagram of a CPU chipset configuration according to one embodiment.

FIG. 7 is a layout diagram of a CPU chipset configuration according to another embodiment.

FIG. 8 is a flow diagram to configure the memory access for a CPU chipset according to one embodiment.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a CPU chipset is divided into a number of clusters according to the memory controllers available to the processing cores of the CPU chipset. The processing cores, the shared cache memory (or cache) available at the CPU chipset are affinitized (or associated) to the memory controllers to achieve fast data fetches between the core and the cache and between the cache and the memory controller.

Conventionally, in a multi-core CPU with a shared cache architecture, the processing cores can read from/write to any of the shared cache at the CPU. The shared cache can receive data from/send data to any memory controller at the CPU chipset. However, there is a larger latency between cores and cache, and between cache and the memory controller when the operating system fetches data using routes from the cache to the cores and from the cache to the memory controller that are lengthy. A larger latency causes slower execution of instructions leading to a lower CPU performance.

In one embodiment, a system determines a plurality of memory controllers available at a central processing unit (CPU) chipset of an autonomous driving system (ADS) for an autonomous driving vehicle (ADV), the CPU chipset having a plurality of processing cores. The system partitions the plurality of memory controllers at the CPU chipset into N regions. The system determines a shared cache memory at the CPU chipset that is shared among the plurality of processing cores. The system partitions the shared cache memory into N segments according to the N regions. The system configures CPU chipset settings to associate for each memory controller in the N regions to a segment of the shared cache memory in the respective region. Data and/or instruction sets are accessed by the CPU chipset from a memory controller through a segment of the cache memory that is associated to the memory controller. The association minimizes the trace routes from the shared cache memory to the memory controller. Through the associations, only the shared cache memory associated to a memory controller are used when data is accessed from an external memory module for the particular memory controller. This ensures a minimum fetch time for data/instruction access from the memory controller.

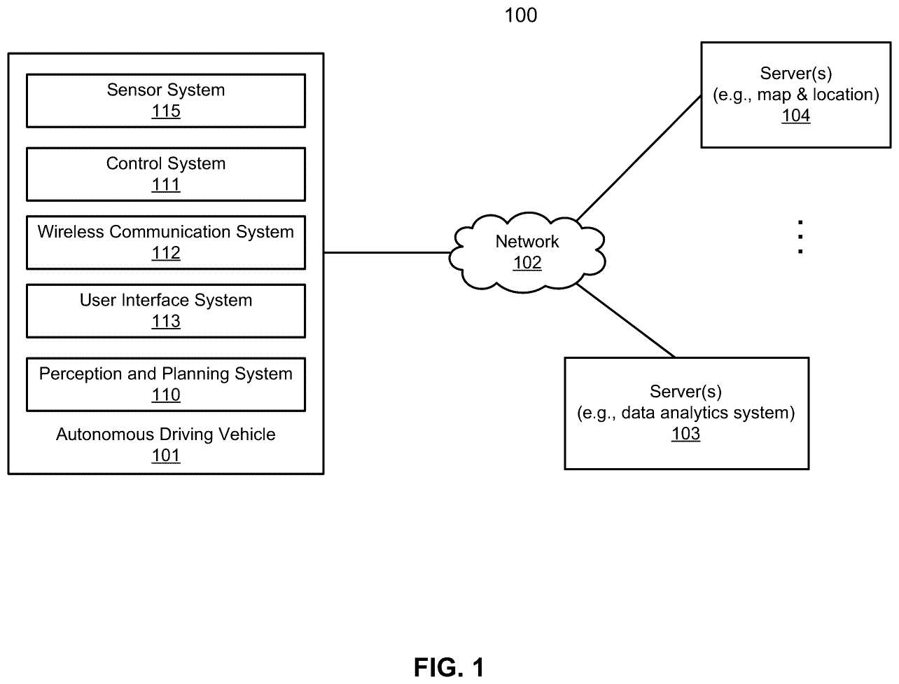

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

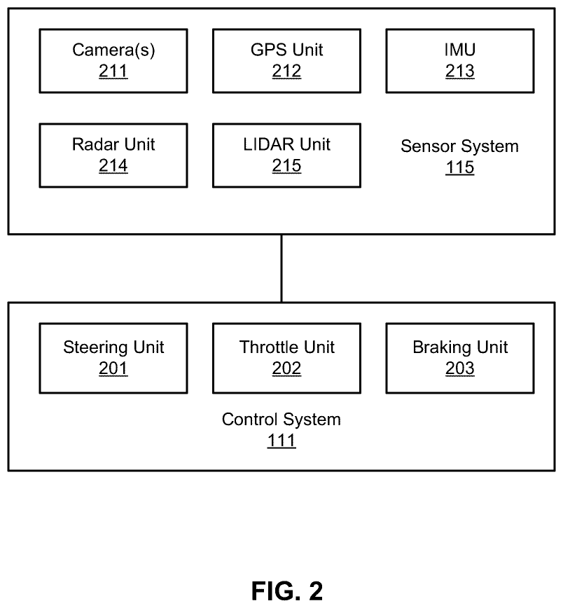

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

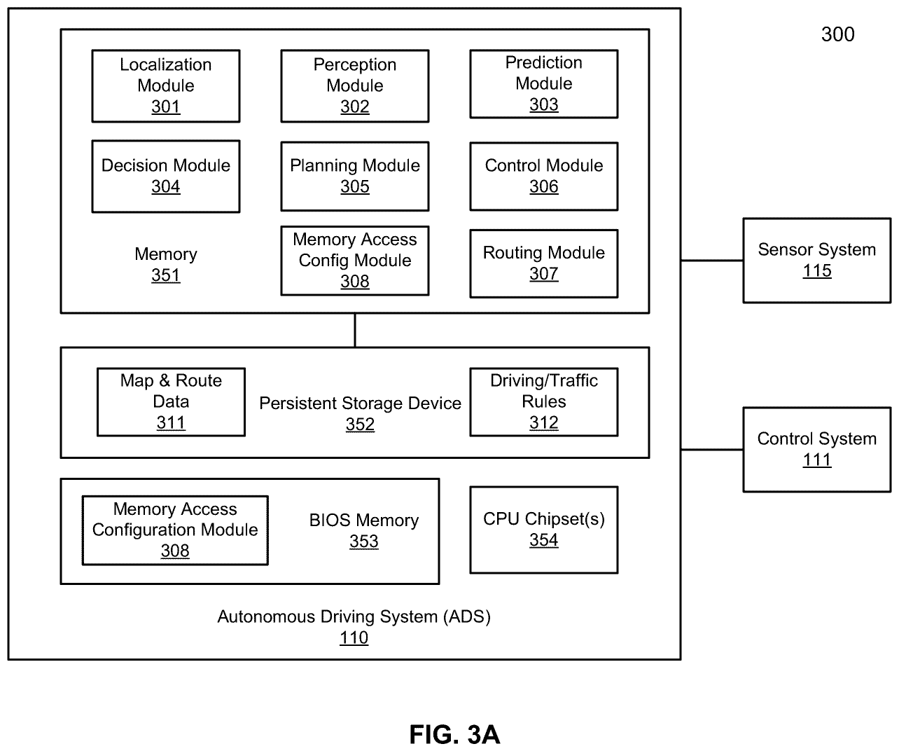

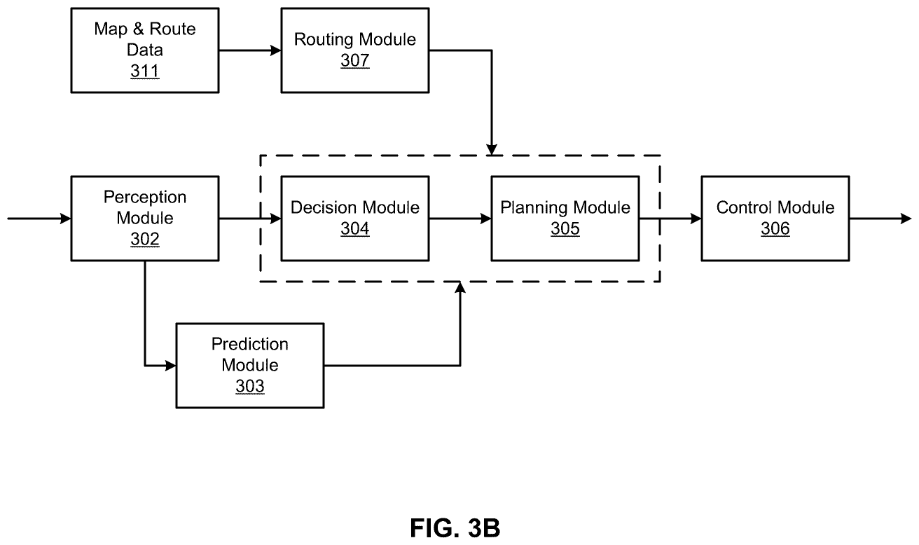

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, and memory access configuration module 308.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

In one embodiment, ADS 110 can include memory access configuration module 308. Memory access configuration module 308 can affinitize (e.g., configure access associations) the processing cores and/or the shared cache memory to one or more memory controllers for a CPU chipset. Module 308 may be implemented in software, hardware, or a combination thereof. In some embodiments, module 308 can be loaded into a BIOS memory 353, and executed by one or more CPU processors to configure CPU chipset(s) 354 at boot up. Boot up is a startup sequence that starts the operating system of a computing platform when it turns on.

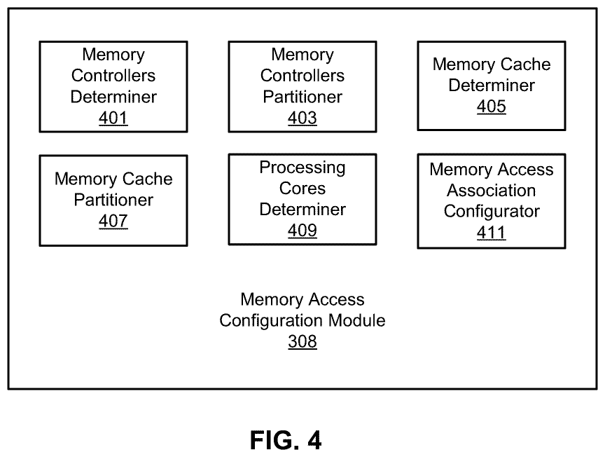

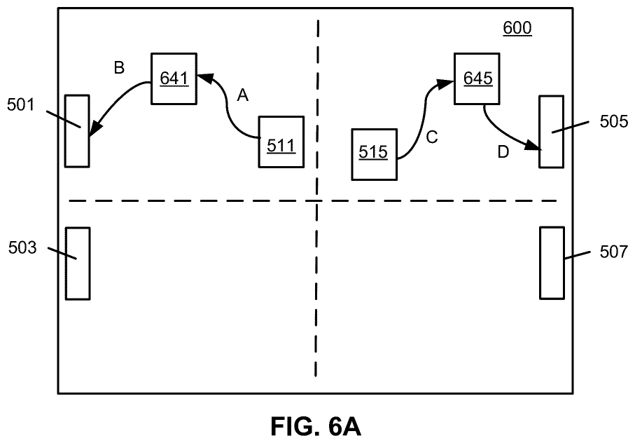

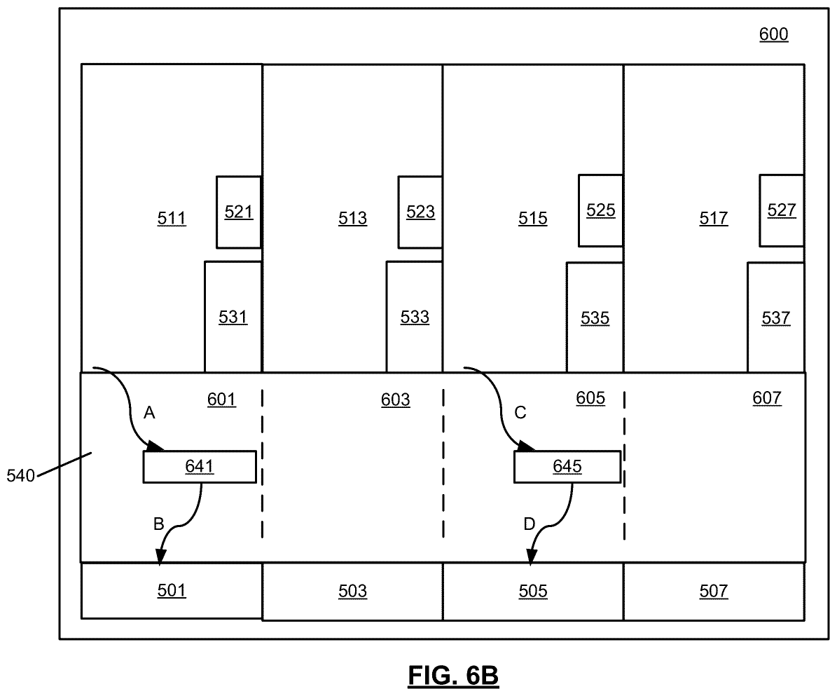

FIG. 4 is a block diagram of a memory access configuration module 308 according to one embodiment. Memory access configuration module 308 can configure the settings for a CPU chipset in a CPU socket. The settings can cause the processing cores, cache memory, and memory controllers of a CPU to be affinitized. Processing cores in each cluster is affinitized to only utilize the resources in the cluster, as further shown in FIGS. 6A-6B. In one embodiment, module 308 includes submodules: memory controllers determiner 401, memory controller partitioner 403, cache memory determiner 405, cache memory partitioner 407, processing cores determiner 409, and memory access association configurator 411. Memory controllers determiner 401 can determine a plurality of memory controllers available at a central processing unit (CPU) chipset of ADV 110. The memory controllers are circuitry for the CPU to access external memory modules of the ADS. The CPU chipset can be any CPUs that have access to more than one memory controllers, including CPUs from ventors such as Intel™, AMD™, Apple™, ARM™, HiSilicon™, etc. In one embodiment, the memory controllers are internal memory controller circuitries disposed at the CPU die for the CPU socket. In some embodiments, the memory controllers are external memory controllers disposed at the motherboard of the ADS computing platform. Memory controller partitioner 403 can partition the memory controllers into N partitions (or clusters), where N is greater than 1. In one embodiment, N is the number of memory controllers. That is, memory controllers and resources at the CPU are divided into N clusters. Cache memory determiner 405 can determine the sharable cache memory available to the processing cores. The sharable cache memory can be any of level 1-L1, level 2-L2, or level 3-L3 cache memory that are shared among the processing cores. Cache memory partitioner 407 can partition the sharable cache memory into N partitions (clusters). For example, specific memory blocks in the cache can be preconfigured by a programmer to belong to specific clusters in a BIOS programmable ROM. Processing cores determiner 409 can determine the available processing cores at the CPU chipset and determine which processing cores belong to which clusters. Memory access association configurator 411 can configure the association settings among the processing cores, sharable cache memory, and memory controllers to specify the clusters so that the cores only access cache resources within their respective clusters.

Some or all of modules 401-411 may be implemented in software, hardware, or a combination thereof. For example, these modules may be programmed into BIOS Rom 353 and executed by one or more processors. Some of modules 401-411 may be integrated together as an integrated module.

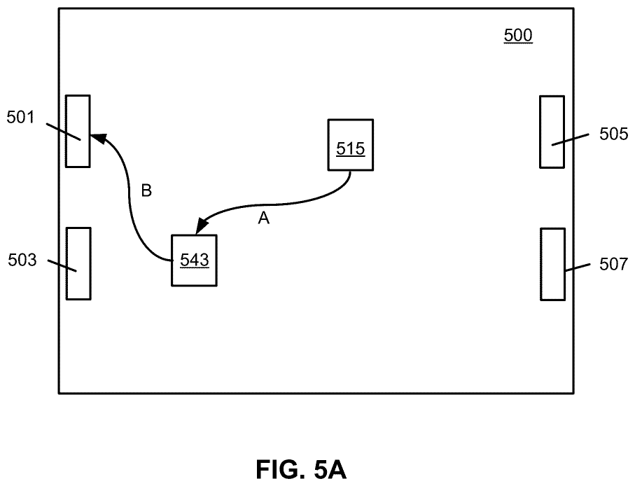

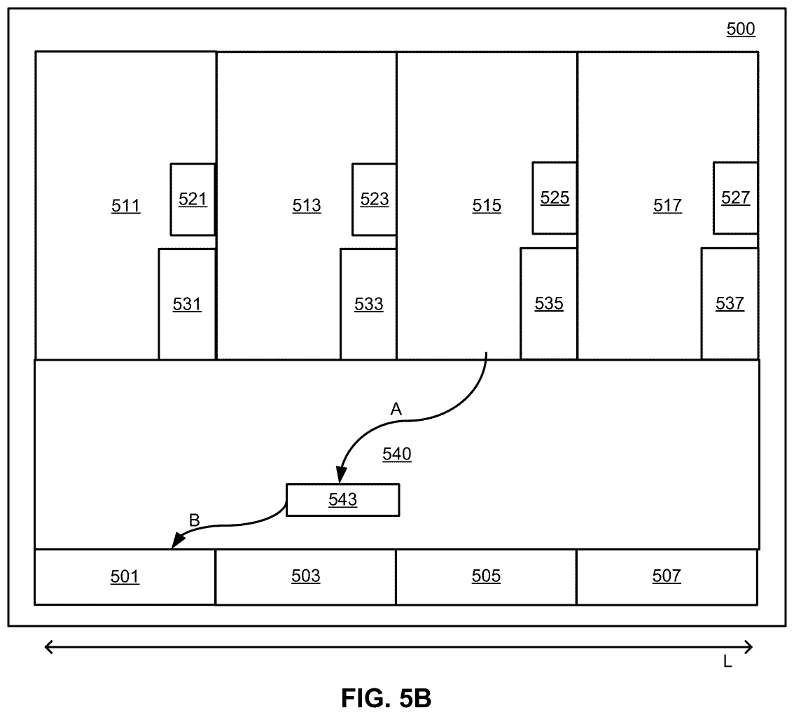

FIGS. 5A-5B is a block diagram and a layout diagram of a CPU chipset according to one embodiment. CPU chipset 500 can be a chipset unit with one or more dies for a CPU socket. CPU chipset 500 can be one of many CPU chipsets used for application processing tasks at an ADS of an ADV. In one embodiment, the processing task includes executing multi-threaded applications/tasks, where more than one processing cores are actively performing a same or different workload. In one embodiment, the processing task includes tasks that would fetch data from the L3 cache memory of the CPU chipset and/or the main memory 351 (e.g., a memory module external to the CPU) of ADS. Here, a “cache miss” has occurred when the application task has to fetch data from the main memory.

Referring to FIGS. 5A-5B, chipset configuration 500 can include one or more memory controllers 501-507, one or more processing cores 511-517, L1 cache memory 521-527, L2 cache memory 531-537, and L3 cache memory 540. L1-L3 cache memory can be chip-based computing component (e.g., SRAM) that facilitate retrieval of data from the main memory (e.g., external memory modules, such as DRAM) of a computing platform. Cache memory can be a temporary storage area for the processors of a computing platform. This temporary storage area is readily available to the processor compared to the main memory. For example, when a processor accesses data from a memory address of the main memory, the processor first looks at L1 cache and determines if the data is present at L1. In some embodiments, the L1 cache is embedded within each individual core of the CPU. L1 cache can transfer data at the fastest rate, thus, L1 cache is extremely efficient. If the processor found the required data in L1, data is return to the processor and a “cache hit” has occurred. If the processor fails to find the required data in L1, the processor looks for the data in the L2 and/or L3 cache.

L2 cache is a secondary memory cache. In some embodiments, the L2 cache is embedded within each individual core of the CPU. L2 cache can have more storage space than L1 cache, but it operates at a slower speed than L1 cache. L3 cache can be a shared storage pool that all processing cores can access. L3 cache is slower than L1 and L2 cache, but is larger than L1 and L2 cache and is faster than the main memory. If the processor fails to find the data it needs in the L1-L3 cache memory, the processor then requests the data from the main system memory and a cache miss has occurred.

In one embodiment, as shown in the scenario of FIGS. 5A-5B, L1 and L2 caches are privately accessible to the processing cores but L3 cache memory is available (shared) among all processing cores 511-517 of CPU chipset 354. In some embodiments, L1/L2 cache memory are sharable among the processing cores of CPU chipset 354.

Referring to the layout in FIG. 5B, L3 cache 540 can be distributed along a length L of the chipset along cores 511-517. In some embodiments, the memory controllers (or addresses of memory modules) are accessible by any processing cores. In some embodiments, main memory addresses are mapped to specific lines (or blocks) of cache memory no matter which core accesses the memory address, this way all cores agree on where in a cache a piece of data is. In some embodiments, the L1/L2/L3 cache are configured to be directly mapped, n-way set associative, or fully associative. The cache can be addressable by the tag, index (set), and offset bits. For example, a 4-way set associative can have numerous sets, where each set has 4 blocks. Here, the index bits specify which set, and the tag bits specifies which of the 4 blocks in a set is mapped to content of the main memory. The offset bits can specify a portion of the cache block. In a fully associative, the index (set) bits is not required and a cache block can be placed anywhere in the cache. In a direct mapping, a cache block is mapped to one spot in the cache. In some embodiments, when the cache is full, a least recently used (LRU) scheme, or other schemes, can be used to vacate old data from the cache to make space available for new data.

Referring to FIGS. 5A-5B, because the addresses of memory modules are accessible by any processing cores, there leads to the scenario where processing core 515 access cache block 543 which in turn accesses memory controller 501, all of which are spatially apart leading to a higher latency. That is, cache memory with various values (e.g., offset, set, or tag) in the address space when accessed by a particular processing core have different performance characteristics.

FIGS. 6A-6B is a block diagram and a layout diagram of a CPU chipset configuration 600 according to one embodiment. Configuration 600 can represent configuration 500 of FIGS. 5A-5B but with a non-uniform memory access for the CPU. Here, memory controller 501 can be grouped with processing core 511 and/or cache 601 so only processing core 511 and/or cache 601 can access memory addresses from memory controller 501. Controller 503 is grouped with processing core 513 and/or cache 603 so only processing core 513 and/or cache 603 can access memory addresses from memory controller 503. Controller 505 is grouped with processing core 515 and/or cache 605 so only processing core 515 and/or cache 605 can access memory addresses from memory controller 505. Controller 507 is grouped with processing core 517 and/or cache 607 so only processing core 517 and/or cache 607 can access memory addresses from memory controller 507. In some embodiments, memory controller 501 can be grouped with processing core 511 and/or cache 601 by specifying clusters/zones/regions for the CPU. In some embodiments, the zones can be specified in the system utility of the operating system (e.g., specifying the non-uniform memory access (NUMA) group size optimization setting for the operating system to be a cluster mode) of the ADS computing platform and the computing platform can restart for the setting to take effect. In some embodiments, the zones can be specified in the BIOS settings (e.g., enabling advanced configuration power interface (ACPI) system resource affinity table (SRAT) L3 cache As NUMA Domain). In some embodiments, the NUMA information for each CPU chipset is provided to the BIOS by a programmer. For example, a programmer can specify the process cores, the memory controllers, and the sets for the L3 cache memory for the CPU chipset and specify the NUMA zone boundaries in BIOS programming accordingly.

Referring to FIGS. 6A-6B, because the addresses of memory modules (or memory controllers) and/or L3 cache 540 are affinitized to the processing cores, e.g., the memory controllers and processing cores are grouped into N clustered, where N can be the number of memory controllers, the processing cores would only access memory addresses at the memory controller within its cluster. Here, processing core 511 accesses data from cache block 641 (within L3 cache zone 601) and/or memory controller 501. Processing core 515 accesses data from cache block 645 (within L3 cache zone 605) and/or memory controller 505, etc. Due to spatial locality, processing core having restricted memory accesses to memory addresses at memory controller(s) within its zones would lead to a lower latency and better performance.

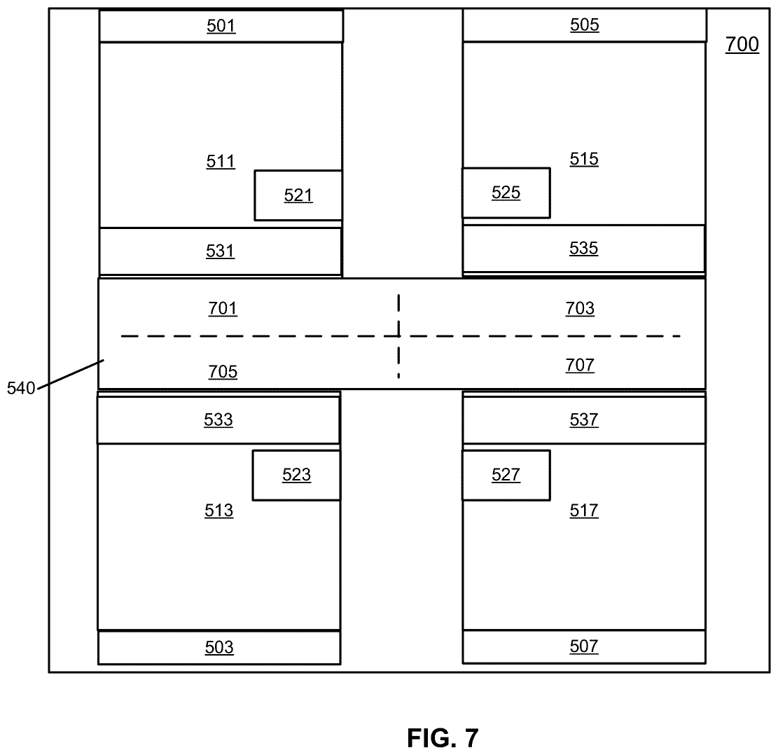

FIG. 7 is a layout diagram of a CPU chipset configuration 700 according to another embodiment. Configuration 700 can represent configure 600 of FIGS. 6A-6B but with L3 cache 540 situated near a center location of the processing cores. Referring to FIG. 7, cache 540 can be zoned into sets 701-707 and the sets are clustered with processing cores 511-517 and/or memory controllers 501-507 according to its spatial placements. E.g., set 701 is grouped with core 501 and memory controller 511, set 703 is grouped with core 503 and memory controller 513, set 705 is grouped with core 505 and memory controller 515, and set 707 is grouped with core 507 and memory controller 517. The specified zone groupings would restrict processing cores to access resources within its zones, thus, leads to a lower latency. Although FIG. 7 shows L3 cache being in a center location of the processing cores, the L3 cache can be on a left, a right, a top, or a bottom location with respect to the processing cores. In some embodiments, the L3 cache are disposed at multiple locations with respect to the processing cores.

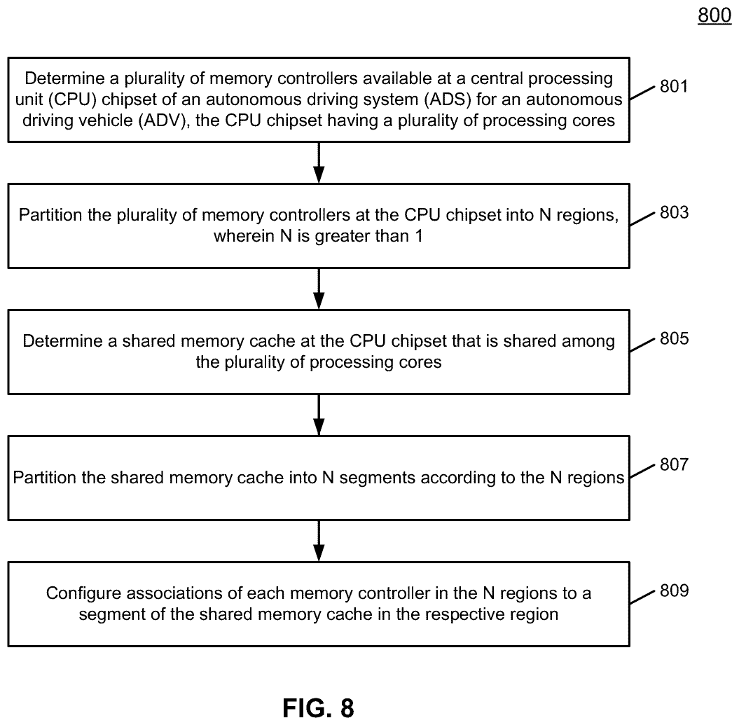

FIG. 8 is a flow diagram to configure the memory access for a CPU chipset according to one embodiment. Process 800 may be performed by processing logic which may include software, hardware, or a combination thereof. Process 800 may be performed by module 308 of FIG. 3A.

Referring to FIG. 8, at block 801, processing logic determines a plurality of memory controllers available at a central processing unit (CPU) chipset of an autonomous driving system (ADS) for an autonomous driving vehicle (ADV), the CPU chipset having a plurality of processing cores.

At block 803, processing logic partitions the plurality of memory controllers at the CPU chipset into N regions, where N is greater than 1.

At block 805, processing logic determines a shared cache memory at the CPU chipset that is shared among the plurality of processing cores.

At block 807, processing logic partitions the shared cache memory into N segments according to the N regions.

At block 809, processing logic configures CPU chipset settings to associate each memory controller in the N regions to a segment of the shared cache memory in the respective region, where data and/or instruction sets are accessed by the CPU chipset from a memory controller through a segment of the cache memory that is associated to the memory controller.

In one embodiment, processing logic further determines a plurality of processing cores at the CPU chipset that have access to the plurality of memory controllers and configures the CPU chipset settings to associate each memory controller to a subset of the plurality of processing cores according to the N regions, where the data is accessed by a processing core in a same region as the segment of the cache memory that is associated to the memory controller.

In one embodiment, a number of memory controllers at the CPU chipset is N.

In one embodiment, the shared cache memory includes a level 3 (L3) cache memory having memory segments distributed over a length in a layout of the CPU chipset.

In one embodiment, the plurality of memory controllers are integrated in the CPU chipset.

In one embodiment, associating each memory controller in the N regions to a segment of the shared cache memory in the respective region is performed when the ADS is booting.

In one embodiment, associating each memory controller in the N regions to one or more of the plurality of processing cores in the respective region is performed when the ADS is booting.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
determining a plurality of memory controllers available at a central processing unit (CPU) chipset of an autonomous driving system (ADS) for an autonomous driving vehicle (ADV), the CPU chipset having a plurality of processing cores;
partitioning the plurality of memory controllers at the CPU chipset into N regions, wherein N is greater than 1;
determining a shared cache memory at the CPU chipset that is shared among the plurality of processing cores;
partitioning the shared cache memory into N segments according to the N regions; and
configuring CPU chipset settings to associate each memory controller in the N regions to a segment of the shared cache memory in the respective region, wherein data and/or instruction sets are accessed by the CPU chipset from a memory controller through a segment of the cache memory that is associated to the memory controller.

2. The method of claim 1, further comprising:
determining a plurality of processing cores at the CPU chipset that have access to the plurality of memory controllers;
configuring the CPU chipset settings to associate each memory controller to a subset of the plurality of processing cores according to the N regions, wherein the data is accessed by a processing core in a same region as the segment of the cache memory that is associated to the memory controller.

3. The method of claim 1, wherein a number of memory controllers at the CPU chipset is N.

4. The method of claim 1, wherein the shared cache memory includes a level 3 (L3) cache memory having memory segments distributed over a length in a layout of the CPU chipset.

5. The method of claim 1, wherein the plurality of memory controllers are integrated in the CPU chipset.

6. The method of claim 1, wherein associating each memory controller in the N regions to a segment of the shared cache memory in the respective region is performed when the ADS is booting.

7. The method of claim 2, wherein associating each memory controller in the N regions to one or more of the plurality of processing cores in the respective region is performed when the ADS is booting.

8. A non-transitory machine-readable medium having instructions stored therein, which when executed by a processor, cause the processor to perform operations, the operations comprising:
determining a plurality of memory controllers available at a central processing unit (CPU) chipset of an autonomous driving system (ADS) for an autonomous driving vehicle (ADV), the CPU chipset having a plurality of processing cores;
partitioning the plurality of memory controllers at the CPU chipset into N regions, wherein N is greater than 1;
determining a shared cache memory at the CPU chipset that is shared among the plurality of processing cores;
partitioning the shared cache memory into N segments according to the N regions; and
configuring CPU chipset settings to associate each memory controller in the N regions to a segment of the shared cache memory in the respective region, wherein data and/or instruction sets are accessed by the CPU chipset from a memory controller through a segment of the cache memory that is associated to the memory controller.

9. The machine-readable medium of claim 8, wherein the operations further comprise:
determining a plurality of processing cores at the CPU chipset that have access to the plurality of memory controllers;
partitioning the plurality of processing cores according to the N regions; and
configuring the CPU chipset settings to associate each memory controller to a subset of the plurality of processing cores according to the N regions, wherein the data is accessed by a processing core in a same region as the segment of the cache memory that is associated to the memory controller.

10. The machine-readable medium of claim 8, wherein a number of memory controllers at the CPU chipset is N.

11. The machine-readable medium of claim 8, wherein the shared cache memory includes a level 3 (L3) cache memory having memory segments distributed over a length in a layout of the CPU chipset.

12. The machine-readable medium of claim 8, wherein the plurality of memory controllers are integrated in the CPU chipset.

13. The machine-readable medium of claim 8, wherein associating each memory controller in the N regions to a segment of the shared cache memory in the respective region is performed when the ADS is booting.

14. The machine-readable medium of claim 9, wherein associating each memory controller in the N regions to one or more of the plurality of processing cores in the respective region is performed when the ADS is booting.

15. A data processing system, comprising:
a processor; and
a memory coupled to the processor to store instructions, which when executed by the processor, cause the processor to perform operations, the operations including determining a plurality of memory controllers available at a central processing unit (CPU) chipset of an autonomous driving system (ADS) for an autonomous driving vehicle (ADV), the CPU chipset having a plurality of processing cores;
partitioning the plurality of memory controllers at the CPU chipset into N regions, wherein N is greater than 1;
determining a shared cache memory at the CPU chipset that is shared among the plurality of processing cores;
partitioning the shared cache memory into N segments according to the N regions; and
configuring CPU chipset settings to associate each memory controller in the N regions to a segment of the shared cache memory in the respective region, wherein data and/or instruction sets are accessed by the CPU chipset from a memory controller through a segment of the cache memory that is associated to the memory controller.

16. The system of claim 15, wherein the operations further comprise:
determining a plurality of processing cores at the CPU chipset that have access to the plurality of memory controllers;
partitioning the plurality of processing cores according to the N regions; and
configuring the CPU chipset settings to associate each memory controller to a subset of the plurality of processing cores according to the N regions, wherein the data is accessed by a processing core in a same region as the segment of the cache memory that is associated to the memory controller.

17. The system of claim 15, wherein a number of memory controllers at the CPU chipset is N.

18. The system of claim 15, wherein the shared cache memory includes a level 3 (L3) cache memory having memory segments distributed over a length in a layout of the CPU chipset.

19. The system of claim 15, wherein the plurality of memory controllers are integrated in the CPU chipset.

20. The system of claim 15, wherein associating each memory controller in the N regions to a segment of the shared cache memory in the respective region is performed when the ADS is booting.
